(19) United States
(12) Patent Application Publication
(10) Pub. No.: US 2002/0154331 A1
(43) Pub. Date: Oct. 24, 2002

(54) Image data transmission apparatus and image data receiving apparatus

(75) Inventors: Hideki Yamauchi, Ogaki (JP); Tatsushi Ohyama, Ogaki (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Sanyo Electric Co., Ltd.

(21) Appl. No.: 10/077,136

(22) Filed: Feb. 14, 2002

(30) Foreign Application Priority Data
Feb. 26, 2001 (JP) 2001-051115

(51) Int. Cl. B41J 1/00; G06F 15/00

(52) U.S. Cl. 358/1.15

(57) ABSTRACT

An image data transmission apparatus comprising: a transmission unit that transmits image data; and a control unit that controls the amount of image data to be transmitted in accordance with information concerning the transmission rate of the image data. An image data receiving apparatus comprising: a receiving unit that receives image data; and a control unit that controls the amount of image data received in accordance with information concerning the transmission rate of the image data.

### BACKGROUND OF THE INVENTION

1. Field of the Invention

The present invention relates to a technology for transmitting image data and it particularly relates to an apparatus for transmitting and receiving image data.

2. Description of the Related Art

In recent years digital image culture has become commonplace in our daily life as various information devices such as personal computers, digital cameras and color printers have been introduced into our homes and the number of the people using the Internet has exploded. Image compression technology such as JPEG (Joint Photographic Expert Group) and MPEG (Motion Picture Expert Group) for still pictures and motion pictures respectively have been standardized. Image distribution and reproduction have become easy and convenient for users using recording media such as CD-ROM and transmission media such as networks and broadcasting technology on the basis of the aforementioned image compression technology. JPEG 2000 has been announced in the JPEG line of technology. As for MPEG, future target specifications have been planned and discussed as well.

As described above, the more image distribution and reproduction are improved, the more images are transmitted through networks between the information devices such as personal computers. Furthermore, people are using mobile phones and PDAs (Personal Digital Assistants) for receiving images through networks. Thus, real-time motion image distribution services for various types of devices are bound to become important business matters.

However, when images are distributed through networks, the receiver cannot see the images for a considerable period because of the traffic congestion on the network. When motion pictures are distributed, the receiver often cannot see the motion pictures in real time.

Furthermore, even when there is no traffic congestion on the network, as the receiver uses a relatively small device such as a mobile phone or a PDA, the processing speed of the device is not sufficient for the motion pictures to be displayed in real time.

### SUMMARY OF THE INVENTION

The present invention has been made in view of the foregoing circumstances and an object thereof is to provide a technology that enables smooth image reconstruction.

According to one aspect of the present invention, an image data transmission apparatus is provided. The apparatus comprises: a transmission unit that transmits image data; and a control unit that controls the amount of image data to be transmitted, in accordance with information concerning the transmission rate of a network through which the image data are to be transmitted. The “amount of image data to be transmitted” means the amount of data to be transmitted in order to display a single image or a plurality of images. The control unit may refer to information concerning the transmission rate, and may control the amount of image data to be transmitted. For example, the control unit may reduce the amount of data to be transmitted when the transmission rate on the network is slow. Thus, image data can be transmitted to a receiving apparatus at a constant speed regardless of the transmission rate of the network. Therefore, the receiving apparatus can display the image data smoothly.

The control unit may calculate the information concerning the transmission rate on the basis of a measured value of the transmission rate of a network through which the image data is to be transmitted and may control the amount of image data to be transmitted in accordance with this calculation. The measured value may be an experimental value or may be obtained by measuring the transmission rate of previously transmitted data. In either case, the measured value may be stored in the transmission apparatus as a table so that the control unit can obtain the measured value by just referring to the table. The control unit may obtain the measured value of the transmission rate while transmitting the image data, and may control the amount of image data to be transmitted in accordance with the measured value.

According to another aspect of the present invention, an image data transmission apparatus is provided. The apparatus comprises a transmission unit that transmits image data; and a control unit that controls the amount of image data to be transmitted in accordance with information concerning a receiving apparatus that receives the image data. The “information” may concern the type of the receiving apparatus, memory capacity of the receiving apparatus, or any information related to the receiving apparatus. With this information, the transmission apparatus can transmit the image data that satisfies the requirements of the receiving apparatus.

The image data may be a motion picture, and in this case the control unit may control the amount of image data in accordance with the information received without reducing the number of frames included in the motion picture. By means of this operation, the number of frames in the motion picture are maintained, and the receiving apparatus can display the motion picture smoothly.

The control unit may refer to a processing speed or a display condition of the receiving apparatus as the information. The “display condition” may be the size of the display of the receiving apparatus, whether the display is in monochrome or color, or the numbers of colors that the display can show. With this information, the transmission apparatus can transmit the image data appropriate for the receiving apparatus.

The transmission apparatus may further comprise a compression unit and a control unit which may control the compression unit to adjust resolution of the image data in accordance with the information received. The control unit may control the compression unit to extract lower frequency components from the image data and eliminate higher frequency components from the image data in accordance with the information. It is known that the lower frequency components of image data can reconstruct the basic structure of the image data to a certain extent. The control unit may control the compression unit to reduce bit numbers dedicated to each pixel of the image data according to the information.

According to another aspect of the present invention, an image data receiving apparatus is provided. The apparatus comprises a receiving unit that receives image data; and a control unit that controls the amount of image data to be received in accordance with information concerning the transmission rate of a network through which the image data is to be transmitted. The control unit may reduce the amount of image data to be received when the transmission rate is slow. When the receiving apparatus cannot receive all of the data transmitted from a transmission apparatus, the receiving apparatus may inform the transmission apparatus of the fact, or the receiving apparatus may just ignore the fact. In either case, with this method of operation, incoming image data can be received without delay.

The control unit may calculate the information concerning the transmission rate on the basis of measured value of the transmission rate of a network through which the image data are to be transmitted and may control the amount of image data to be received in accordance with the calculation. The control unit may obtain measured value of the transmission rate while receiving the image data, and may control the amount of image data to be received in accordance with the measured value.

According to another aspect of the present invention, an image data receiving apparatus is provided. The apparatus comprises a receiving unit that receives image data; a decoding unit that performs data processing on the received data; and a control unit that controls the amount of image data to be received, in accordance with information concerning the performance speed of the decoding unit. The data processing may be conducted by any processes necessary for displaying the image data. The data processing may be, for example, decoding the data which have been encoded by the transmission apparatus. With this operation, the data can be processed smoothly and without delay.

The control unit may refer to information concerning the specification of the display unit and may control the amount of image data in accordance with the specification. With this operation, the receiving apparatus can be prevented from receiving irrelevant data that are useless to the display unit.

The control unit may monitor the amount of received data and may instruct a transmission apparatus to terminate transmission of image data when the amount of received data reaches a predetermined amount. The received data may “reach a predetermined amount” when the receiving apparatus receives a predetermined quantity and when the receiving apparatus receives a predetermined component of the image data as well. With this information, the transmission apparatus may cease transmitting the remaining image data. When the image data is a motion picture, the control unit may control the amount of image data in accordance with the information without reducing the number of frames included in the motion picture.

According to another aspect of the present invention, an image transmitting method is provided. The method comprises: transmitting image data; and controlling the amount of image data to be transmitted in accordance with information concerning the transmission rate of a network through which the image data are to be transmitted.

According to another aspect of the present invention, an image transmitting method is provided. The method comprises: transmitting image data; and controlling the amount of image data to be transmitted in accordance with information concerning a receiving apparatus that receives the image data.

According to another aspect of the present invention, an image receiving method is provided. The method comprises: receiving image data; and controlling the amount of image data to be received in accordance with information concerning the transmission rate of a network through which the image data are to be transmitted.

According to another aspect of the present invention, an image receiving method is provided. The method comprises: receiving image data; performing data processing on the received data and controlling the amount of image data to be received, in accordance with information about the performance speed of the data processing.

According to another aspect of the present invention, an image receiving method is provided. The method comprises: receiving image data; performing data processing on the received data and controlling the amount of image data to be received, in accordance with information concerning the specification of a display unit that displays the image data.

This summary of the invention does not necessarily describe all necessarily features, so that the invention may also be a sub-combination of these described features.

### BRIEF DESCRIPTION OF THE DRAWINGS

FIG. 1 shows the process of encoding and decoding image data in accordance with JPEG 2000.

FIG. 2 shows an image transmission network system according to a first embodiment of the present invention.

FIG. 3 shows the internal structure of the transfer condition table.

FIG. 4 shows an image transmission network system according to a second embodiment of the present invention.

FIG. 5 shows an image transmission network system according to a third embodiment of the present invention.

### DETAILED DESCRIPTION OF THE INVENTION

The invention will now be described with reference to the preferred embodiments, which do not intend to limit the scope of the present invention, but exemplify the invention. All of the features and the combinations thereof described in the embodiment are not necessarily essential to the invention.

In this embodiment, a system includes a transmission apparatus and a receiving apparatus. The transmission apparatus encodes image data before transmitting the data to the receiving apparatus. The receiving apparatus receives the encoded data, decodes the data to reconstruct the image data and displays the image data. In this embodiment, the transmission apparatus encodes the image data in accordance with JPEG 2000. The operation of JPEG 2000 for encoding and decoding the image data will be explained in the following.

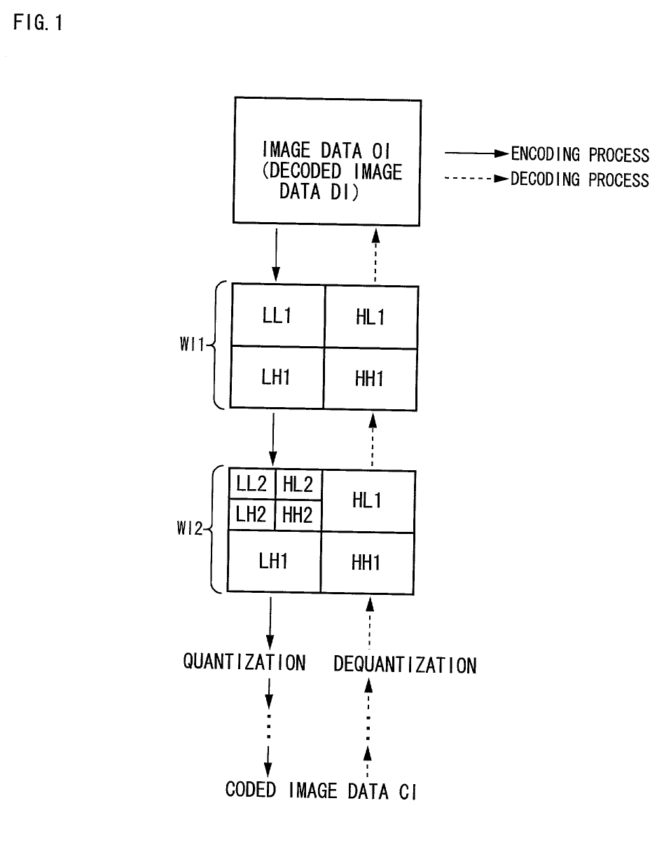

FIG. 1 shows the process of encoding and decoding image data in accordance with JPEG 2000. A first wavelet transform is applied to original image data OI to generate first level image data WI1. A Daubechies filter is employed to apply the wavelet transform to image data in accordance with JPEG 2000. The Daubechies filter simultaneously works as a high-pass filter and a low-pass filter in x and y directions of the image data OI. Then, the image data OI is divided into four sub-bands. The four sub-bands are: an LL sub-band which is composed of low frequency components in both x and y directions, an HL sub-band and an LH sub-band which are composed of low frequency components in one of the x and y directions and high frequency components in the other direction, and an HH sub-band which is composed of high frequency components in both x and y directions. Therefore, as shown in FIG. 1, the first level image data WI1 includes four sub-bands LL1, HL1, LF1 and HH1 each of whose size is one/fourth of the image data OI.

As for the encoding process, the filtering process, i.e., the wavelet transform is applied to image data for a predetermined time. In this embodiment, as shown in FIG. 1, the wavelet transform is applied to the image data OI twice to produce the second level image data WI2. A second wavelet transform is applied only to the LL sub-band in the first level image data WI1. This means that the sub-band LL1 of the first level image data WI1 is divided into four sub-bands LL2, HL2, LH2 and HH2. After the wavelet transform is applied, quantization, bit-plane encoding and arithmetic encoding are performed, and bit stream is generated to obtain the coded image data CI. As for the first level image data WI1 and the second level image data WI2, shown in FIG. 1, the lower frequency components of the image data OI appear at the upper left. Therefore, the sub-band LL2 which is positioned at the upper left of the second level image data WI2 shown in FIG. 1, includes the lowest frequency components. The lower frequency components are more important than the higher frequency components because the lower frequency components enable basic reconstruction of the original image data OI to a certain extent without the higher frequency components.

As for the decoding process, firstly, the coded image data CI are obtained, then bit-stream analysis, arithmetic decoding, bit-plane decoding and dequantization are performed. At this time, the second level image data WI2 is reconstructed. Then, the inverse wavelet transform is applied to the second level image data WI2 to reconstruct the first level image data WI1. The inverse wavelet transform is applied again to the first level image data WI1 to reconstruct the decoded image DI which is formally equivalent to the original image data OI.

The lower frequency components, the sub-band LL2 for example, are placed in leading parts of the bit stream. Thus, the receiving apparatus can receive the important lower frequency components first and reconstruct the image data smoothly. By eliminating the higher frequency components, the image data can be compressed. JPEG 2000 may be used to compress the image data in addition to just encoding the image data, in order to achieve smooth reconstruction.

First Embodiment

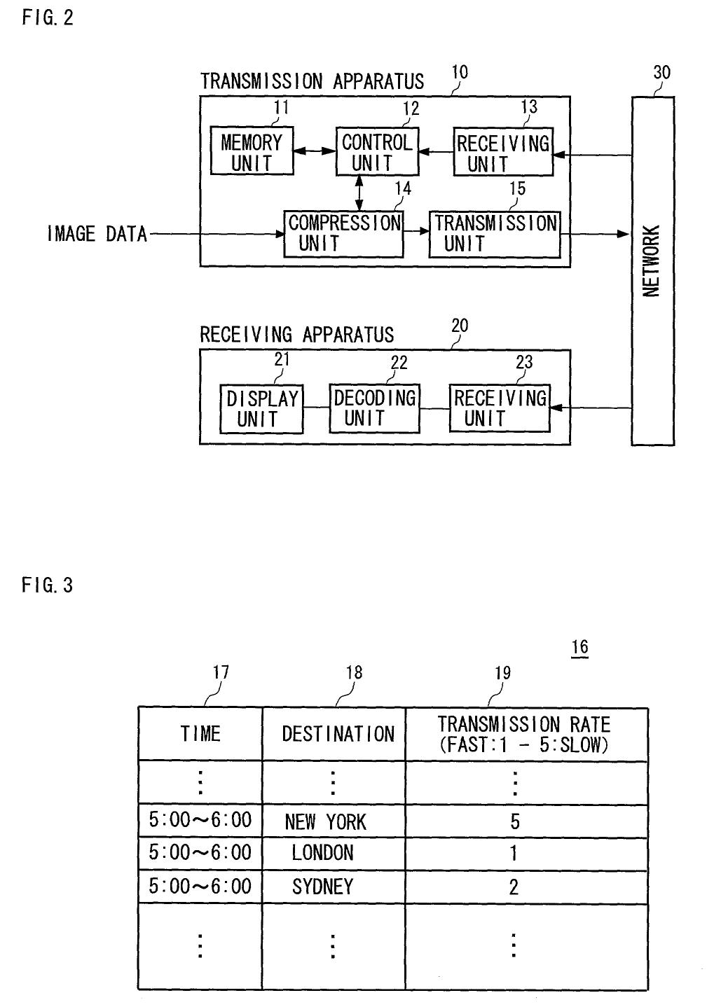

FIG. 2 shows an image transmission network system according to a first embodiment of the present invention. The image transmission network system includes an image data transmission apparatus 10 and an image data receiving apparatus 20. The function of the transmission apparatus 10 and the receiving apparatus 20, respectively, may be actualized by LSI such as a CPU, memory, and/or ASIC (Application Specific Integrated Circuit) as hardware, and program modules capable of transmitting image data or receiving image data loaded on the memory as software. FIG. 2 depicts functional blocks which can be actualized by both the hardware and software. Those skilled in the art understand that the functional blocks can be actualized by hardware only, software only or a combination thereof.

The transmission apparatus 10 and the receiving apparatus 20 are connected with each other through a network 30 such as the Internet. The transmission apparatus 10 includes a memory unit 11, a control unit 12, a receiving unit 13, a compression unit 14, and a transmission unit 15. The memory unit 11 includes a transfer condition table that stores information concerning the transmission rate or traffic density of image data when the data are transferred to a given destination at a certain time.

FIG. 3 shows the internal structure of the transfer condition table 16. The table 16 includes three columns, a time column 17, a destination column 18, and a transmission rate level column 19. The table 16 includes information about the destination areas in which the receiving apparatus 20 should be placed, in the destination column 18. The destination areas can be specified by the IP address of the image data to be transmitted. The table 16 includes information about the approximate times at which the image data should be transferred, in the time column 17. The table 16 includes information concerning the transmission rate corresponding to the time and the destination area, in the transfer condition column 19. The transmission rate shows the transmission rate of the network through which the image data is to be transmitted. In this embodiment, the transmission rate is expressed as 1, 2, 3, 4 and 5, where the smaller number is the faster. These numbers are determined by previously measured values. It can be seen from the table 16 shown in FIG. 3, that during the period from 5:00 a.m. to 6:00 a.m., the image data can be transferred faster to London than to Sydney or New York.

The control unit 12 detects the destination of the image data and the current time. The control unit 12 then refers to the table 16 to detect the transmission rate level corresponding to the destination and the current time. The control unit 12 determines the resolution of the image data on the basis of the transmission rate. In this embodiment, for example, when the transmission rate is two or smaller than two, the control unit 12 instructs the compression unit 14 to compress the image data.

The compression unit 14 receives the image data to be transmitted, and compresses the resolution of the image data in accordance with the instruction from the control unit 12. The compression unit 14 does not change the resolution of the image data unless it receives an appropriate instruction from the control unit 12.

The resolution of the image data may be reduced by any compression method such as trimming, extracting characteristic pixels block by block, using average filters, or simple extraction of pixels.

The control unit 12 may control the compression unit 14 to compress the image data by reducing bit numbers dedicated to each pixel, extracting lower frequency components, or eliminating the color components Cb and Cr of the image data expressed as YCbCr data.

When the image data is a motion picture, the number of frames is maintained and the above compression is performed on each frame. With these operations, even when the traffic rate is not fast, as the transmission apparatus 10 can reduce the amount of image data to be transmitted, the receiving apparatus 20 can obtain the motion picture without delay.

The compression unit 14 then encodes the image data in accordance with JPEG 2000 to generate the coded image data CI. The transmission unit 15 transmits the coded image data CI to the receiving apparatus 20 through the network 30.

At the receiving apparatus 20, the receiving unit 30 receives the coded image data CI through the network 30 and outputs the coded image data CI to the decoding unit 22.

The decoding unit 22 receives the coded image data CI, and performs arithmetic decoding, bit-plane decoding, and dequantization on the coded image data CI. The decoding unit 22 then applies inverse wavelet transform twice to generate the decoded image data DI. The decoding unit 22 outputs the decoded image data DI to the display unit 21. The display unit 21 displays the decoded image data DI on a screen.

As explained above, the amount of image data is reduced when the transmission rate of the network 30 is slow. Thus, the receiving apparatus 20 can reconstruct the image data without any significant delay. Furthermore, even when a motion picture is transmitted as the image data, the number of frames is maintained, thus, the motion picture can be generated at relatively high quality with smooth motion.

The receiving unit 13 of the transmission apparatus 10 can receive the measured value of the transmission rate of the network when the apparatus 10 transmits image data or other data, from the receiving apparatus or other relay terminals, not shown in the drawings, placed somewhere in the destination areas. The receiving unit 13 outputs the received value to the control unit 12. The control unit 12 updates the transmission rate level of the table 16. With this operation, the table 16 can maintain the actual transmission rate of the network.

Second Embodiment

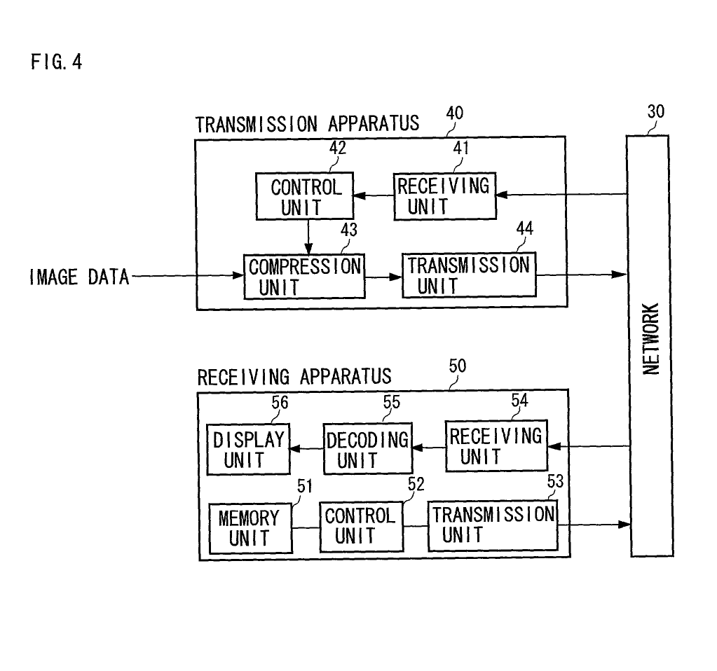

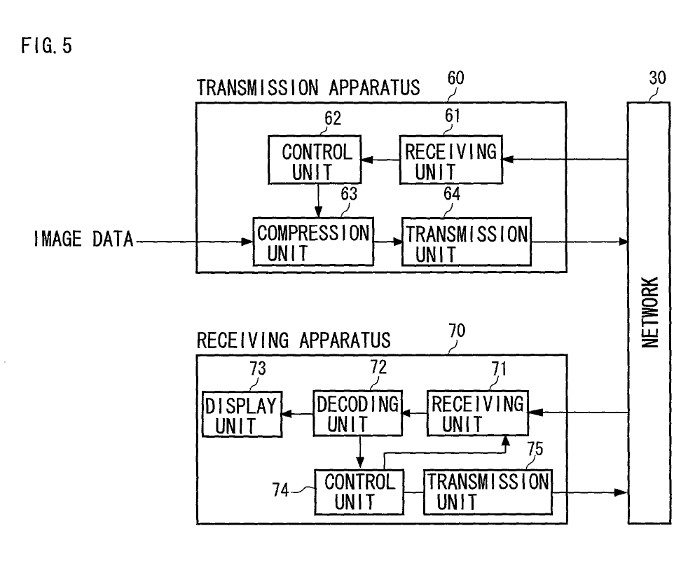

FIG. 4 shows an image transmission network system according to a second embodiment of the present invention. The image transmission network system includes a transmission apparatus 40 and a receiving apparatus 50.

In this embodiment, the receiving apparatus includes a memory unit 51, a control unit 52 and transmitting unit 53 in addition to a receiving unit 54, a decoding unit 55 and a display unit which are similar to those explained for the receiving unit 20 of the first embodiment. The memory unit 51 stores information about the display unit 56. The control unit 52 refers to the memory unit 51 to obtain the information about the display unit 56 and outputs the information to the transmission unit 53. As for the information concerning the display unit 56, the memory unit 51 stores the size of the screen of the display unit 56, whether the display unit 56 is a color display or a monochrome display, or the numbers of colors that the display unit 56 can show, for example. The transmission unit 53 transmits the information about the display unit 56 to the transmission apparatus 40 through the network 30.

The receiving unit 41 of the transmission apparatus 40 receives the information about the display unit 56 and passes it to the control unit 42. The control unit 42 controls the compression rate of the image data on the basis of the information about the display unit 56. For example, when the control unit 42 detects from the information that the size of the display unit 56 is smaller than the original image data, the control unit 42 controls the compression unit 43 to reduce the size of the image data, i.e., to reduce the number of the pixels in the image data. When the control unit 42 detects from the information that the display unit 56 is a monochrome display, the control unit 42 controls the compression unit 43 to eliminate the color components Cb and Cr of the image data expressed as YCbCr data. When the control unit 42 detects from the information the condition that the display unit 56 cannot show all the colors of the original image data, the control unit 42 controls the compression unit 43 to reduce the bit numbers or color numbers in the image data.

The compression unit 43 of the transmission apparatus 40 receives the image data to be transmitted and compresses the image data to the necessary extent in accordance with the instruction from the control unit 42. Then, the compression unit 43 performs encoding processes. When the control unit 42 does not issue an instruction to compress the image data, the compression unit 42 performs normal encoding processes. The transmission unit 44 transmits the coded image data to the receiving apparatus 50 through the network 30.

The receiving unit 54 of the receiving apparatus 50 receives the coded image data CI through the network 30. The receiving unit 54 outputs the received data CI to the decoding unit 55. The decoding unit 55 receives the coded image data CI, performs arithmetic decoding, bit-plane decoding and dequantization on the coded image data CI. The decoding unit 54 then applies inverse wavelet transform twice to generate the decoded image data DI. The decoding unit 54 outputs the decoded image data DI to the display unit 56. The display unit 56 displays the decoded image data DI on a screen.

With the above operation, the receiving apparatus 50 can receive the reduced amount of image data. Thus, unnecessary data which will not be required by the receiving apparatus 50 are not transmitted through the network 30. As the amount of image data that the receiving apparatus 50 receives is reduced, the amount of data that the decoding unit 55 processes will be reduced as well. Thus, the memory capacity of the decoding unit 55 can be reduced. Therefore, the cost of the receiving apparatus 50 can be reduced as well. Furthermore, the receiving apparatus 50 can display the received image data with relatively high quality.

Third Embodiment

FIG. 5 shows an image transmission network system according to a third embodiment of the present invention. The image transmission network system includes a transmission apparatus 60 and a receiving apparatus 70.

In this embodiment, JPEG 2000 can be used for compressing the image data. The receiving apparatus 70 can reconstruct the image data to a certain extent when it receives the LL2 sub-band that includes the lowest frequency components as shown in FIG. 1.

The compression unit 63 of the transmission apparatus 60 obtains target image data to transmit, applies wavelet transform twice, and then performs quantization and other operations to generate the coded image data CI. The transmission unit 64 transmits the coded image data CI to the receiving apparatus 70 through the network 30.

The receiving unit 71 of the receiving apparatus 70 receives the coded image data CI through the network 30 and stores the coded image data CI in a buffer memory, not shown in the drawings, of the decoding unit 72. The decoding unit 72 reads out the coded image data CI from the buffer memory, and performs arithmetic decoding, bit-plane decoding and dequantization on the coded image data CI. The decoding unit 72 then applies inverse wavelet transform twice to generate the decoded image data DI. The decoding unit 72 outputs the decoded image data DI to the display unit 73. The display unit 73 displays the decoded image data DI on a screen.

The control unit 74 detects the operation of the decoding unit 72 and controls the amount of the data received by the receiving unit 71. For example, the control unit 74 monitors the amount of data stored in the buffer of the decoding unit 72. When the control unit 74 detects that the receiving unit 71 receives too much data, so that the buffer memory overflows, the control unit 74 reduces the amount of data to be received by the receiving unit 71. In this embodiment, for example, the control unit 74 terminates the reception of the data after receiving the sub-band LL2. With this operation, the decoding process can be performed smoothly.

In this case, the decoding unit 72 generates the decoded image data DI on the basis of the sub-band LL2. The control unit 74 notifies the transmission apparatus 60 that the amount of the image data reaches a predetermined amount through the transmission unit 75. The receiving unit 61 of the transmission apparatus 60 receives the notification and notifies the control unit 62 accordingly. When the image data is a still picture, the control unit 62 controls the transmission unit 64 to transmit image data. When the image data is a motion picture, the control unit 62 controls the compression unit 63 to start the compression process for the next frame.

With the above operation, the receiving apparatus 70 can terminate the transmission of data that will not be used. Thus, the total amount of data transmitted through the network can be reduced. Furthermore, the receiving apparatus 70 can display the received image data with relatively high quality.

Although the present invention has been described by way of exemplary embodiments, it should be understood that many changes and substitutions may be made by those skilled in the art without departing from the scope of the present invention which is defined by the appended claims. Such changes and substitutions may be provided as follows.

As for the first embodiment, the receiving apparatus 20 may obtain a measured value of the transmission rate of the network 30. Then, the receiving apparatus 20 may inform the transmission apparatus 10 of the transmission rate.

As for the first embodiment, the transmission apparatus 10 may receive information concerning the receiving apparatus 20 from the receiving apparatus 20. Then, the control unit 12 of the transmission apparatus 10 may control the compression unit 14 to compress the image data on the basis of the information concerning the receiving apparatus 20.

As for the third embodiment, the control unit 62 may control the amount of image data to be received on the basis of the transmission rate of the network 30 or the specification of the display unit 73.

As for the third embodiment, the receiving apparatus 70 may receive the bit-stream generated in accordance with JPEG 2000 to a certain extent. For example, if there is enough time for the receiving apparatus to receive the sub-bands LH2, HL2, HH2 . . . , the receiving apparatus may receive those sub-bands.

The transmission apparatus 60 may encode the image data in accordance with MPEG that employs DCT (Discrete Cosine Transform) In this case, the receiving apparatus 70 may cease receiving the coded image data once the receiving apparatus 70 receives the lower frequency components. The present invention can be actualized with a data transmitting method that progressively transmits image data.

The transmission apparatuses 10, 40 and 60 may communicate with any one of the receiving apparatuses 20, 50 and 70, respectively described in the first, second and third embodiments. For example, while the transmission apparatus controls the amount of image data to be transmitted on the basis of the measured value of the transmission rate of the network, the receiving apparatus may control the amount of image data it receives on the basis of the data processing speed of the receiving apparatus. When the receiving apparatus receives sufficient of the data, the receiving apparatus may notify the transmission apparatus accordingly.

The transmission apparatus may control the amount of image data to be transmited on the basis of the transmission rate in real-time. For example, when the transmission rate of the network 30 is fast, the transmission apparatus may transmit all of the coded image data including the higher frequency components and when the transmission rate of the network 30 is slow, the transmission apparatus may transmit only the lower frequency components.

The transmission apparatus may include a database that stores information about the receiving apparatuses. In such a case, the transmission apparatus may control the amount of image data it transmits according to the information about the receiving apparatus.

What is claimed is:

1. An image data transmission apparatus comprising:
a transmission unit that transmits image data; and
a control unit that controls the amount of image data to be transmitted in accordance with information concerning the transmission rate of a network through which said image data are to be transmitted.

2. An apparatus according to claim 1, wherein said control unit calculates said information concerning the transmission rate on the basis of a measured value of the transmission rate, and controls the amount of image data to be transmitted in accordance with the calculation.

3. An apparatus according to claim 1, wherein said control unit obtains a measured value of the transmission rate while transmitting said image data, and controls the amount of image data to be transmitted in accordance with said measured value.

4. An image data transmission apparatus comprising:
a transmission unit that transmits image data; and
a control unit that controls the amount of image data to be transmitted in accordance with information concerning a receiving apparatus that receives said image data.

5. An apparatus according to claim 4, wherein said image data are a motion picture, and wherein said control unit controls the amount of image data to be transmitted in accordance with said information without reducing the number of frames included in said motion picture.

6. An apparatus according to claim 4, wherein said control unit detects performance speed of said receiving apparatus on said image data as said information.

7. An apparatus according to claim 4, wherein said control unit detects the specifications of a display unit of said receiving apparatus as said information.

8. An apparatus according to one of claims 1, further comprising a compression unit that compresses said image data to be transmitted;
wherein said control unit controls said compression unit to adjust resolution of said image data in accordance with said information.

9. An apparatus according to one of claims 1, further comprising a compression unit that compresses said image data to be transmitted;
wherein said control unit controls said compression unit to extract low frequency components from said image data in accordance with said information.

10. An apparatus according to one of claims 1, further comprising a compression unit that compresses said image data to be transmitted;
wherein said control unit controls said compression unit to reduce bit numbers dedicated to each pixel of said image data in accordance with said information.

11. An image data receiving apparatus comprising:
a receiving unit that receives image data; and
a control unit that controls the amount of image data to be received in accordance with information concerning the transmission rate of a network through which said image data are to be transmitted.

12. An apparatus according to claim 11, wherein said control unit calculates said information concerning the transmission rate on the basis of a measured value of the transmission rate, and controls the amount of image data to be received in accordance with the calculation.

13. An apparatus according to claim 11, wherein said control unit obtains a measured value of the transmission rate while receiving said image data, and controls the amount of image data to be received in accordance with said measured value.

14. An image data receiving apparatus comprising:
a receiving unit that receives image data;
a decoding unit that performs data processing on the received data; and
a control unit that controls the amount of image data to be received in accordance with information concerning the performance speed of said decoding unit.

15. An image data receiving apparatus comprising:
a receiving unit that receives image data;
a decoding unit that performs data processing on the received data;
a display unit that displays the processed data; and
a control unit that controls the amount of image data to be received in accordance with information concerning the specification of said display unit.

16. An apparatus according to claim 11, wherein said control unit monitors the amount of received data and instructs a transmission apparatus of to terminate transmission of said image data when the amount of said received data reaches the specified amount.

17. An apparatus according to claim 11, wherein said image data are a motion picture, and wherein said control unit controls the amount of image data in accordance with said information without reducing the number of frames included in said motion picture.

18. An image transmitting method comprising:
transmitting image data; and
controlling the amount of image data to be transmitted, in accordance with information concerning the transmission rate of a network through which said image data are to be transmitted.

19. An image transmitting method comprising:
transmitting image data; and
controlling the amount of image data to be transmitted, in accordance with information concerning a receiving apparatus that receives said image data.

20. An image receiving method comprising:
receiving image data; and
controlling the amount of image data to be received, in accordance with information concerning the transmission rate of a network through which said image data are to be transmitted.

21. An image receiving method comprising:
receiving image data;
performing data processing on the received image data for displaying said image data; and
controlling the amount of image data to be received in accordance with information concerning the performance speed of said data processing.

22. An image receiving method comprising:
receiving image data;
performing data processing on the received image data for displaying said image data; and
controlling the amount of image data to be received in accordance with information concerning the specification of a display unit that displays said image data.
